(19) United States
(12) Patent Application Publication
(10) Pub. No.: US 2025/0270792 A1
(43) Pub. Date: Aug. 28, 2025

(54) Working machine with energy recuperation and method for operating a working machine

(71) Applicants: Liebherr Machines Bulle SA, Bulle (CH); Liebherr-France SAS, Colmar Cedex (FR)

(72) Inventors: Thomas LANDMANN, Eguisheim (FR); Bouzid SEBA, Bulle (CH); Sylvain BOUET, Bulle (CH); Santos-Daniel VINDINHA, Bulle (CH)

(21) Appl. No.: 19/060,309

(22) Filed: Feb. 21, 2025

(30) Foreign Application Priority Data
Feb. 22, 2024 (CH) CH000182/2024

(51) Int. Cl. E02F 9/22; E02F 9/12

(52) U.S. Cl. CPC E02F 9/2217; E02F 9/2246; E02F 9/128

(57) ABSTRACT

The disclosure relates to a working machine comprising an internal combustion engine and at least one secondary pneumatic or hydraulic working circuit, wherein during operation of the secondary working circuit, energy is recuperated and can be supplied to a pressure accumulator of the working machine for energy storage, characterised in that at least one auxiliary compressor is provided, which can be driven by the energy stored in the pressure accumulator, and an engine control unit is provided and configured to recognise a highly dynamic increase in the power demand on the internal combustion engine and, if necessary, to generate additional charge air by means of the auxiliary compressor, which is fed to the charge air path of the internal combustion engine in addition to the regular charge air flow of the internal combustion engine.

### CROSS REFERENCE TO RELATED APPLICATION

The present application claims priority to Swiss Patent Application No. CH000182/2024 filed on Feb. 22, 2024. The entire contents of the above-listed application are hereby incorporated by reference for all purposes.

### TECHNICAL FIELD

The invention relates to a working machine with energy recuperation and a method for operating such a working machine.

### BACKGROUND

Energy recuperation and reuse have long been part of the prior art in the field of vehicle technology. The combination of an internal combustion engine with an electric system for the hybridisation of vehicles is also the most widespread. There are different degrees of hybridisation. In a micro-hybrid vehicle, comparatively low power can be recuperated in relation to the power of the internal combustion engine thereof, which is why the recuperation energy is not used as drive energy, but only to supply secondary functions, such as supplying an electric starter for the internal combustion engine and other electrical consumers in the vehicle. Even during deceleration processes that exceed the time-related kinetic energy of a manoeuvring process, only a small proportion of the excess power can be recuperated. Despite the fact that only a very small proportion of the energy available in principle can be recovered, a micro-hybrid vehicle also has a right to exist within its framework conditions. For example, its additional purchase costs, its additional weight and the additional use of resources are comparatively low compared to a comparable vehicle that, apart from the electric generator, has no means of obtaining additional recuperation power.

### SUMMARY

For vehicles that are already classified in the next higher category of so-called mild hybrid vehicles within hybridisation, considerable additional effort is already required to ensure that purely electric motor-driven manoeuvring operation can take place, that a certain amount of electric motor-generated drive power can be provided in addition to that available from the internal combustion engine and that recuperation can be carried out, the upper power limit of which exceeds that of a micro-hybrid. The relevant classification is not expanded on in the following text.

With regard to possible combinations of drive units, there is not only the combination of an internal combustion engine with an electric motor, or more precisely with an electric drive system, but also combinations of internal combustion engines and flywheel accumulators or hydraulic drive systems including pressure accumulators. The latter category has a high potential for success, especially in the field of mobile working machines, as, unlike in the passenger car sector, for example, there are already high hydraulic power flows and corresponding hydraulic systems are available. For example, the functional and useful integration of a pressure accumulator is known for a serially constructed diesel engine-hydraulic power path of a basic system, e.g. a diesel engine that drives a hydraulic pump to provide hydraulic power for a lifting cylinder or a hydraulic engine.

One example of a working machine that allows sensible energy recuperation during a work cycle is an excavator. Among other things, the actuation of the lift is intended for energy recuperation. (The lift or boom is the segment of the implement attached to the upper carriage; the other two segments are called the bucket and arm.) When lifting this working equipment, a correspondingly high amount of energy must be supplied to the boom hydraulic cylinder in order to achieve the required vertical positioning of the bucket via a swivelling movement of the boom with the help of the arm and bucket. If you consider the length of the possible lever arm and the fact that the bucket is filled with the bulk material during lifting, it becomes clear that very high power is required for the lifting process described. When lowering, even though the bulk material is no longer inside the bucket in most cases, high power levels become available instead, from which recuperation energy can be drawn. For the majority of excavator applications, high power is also required for ploughing the bucket into the bulk material or excavated material. The following power profile results from the considered partial sequences of a working cycle, starting with the lowering of the working equipment, the subsequent pushing of the bucket into the bulk material and the subsequent lifting of the working equipment including the picked up bulk material, in the mentioned sequence and parallel to the working sections:

At the beginning of the lowering process, there is at least a low power requirement and towards the end of the lowering process at the latest, there is power that can be recuperated. During the process of pushing into the bulk material or excavated material, there is instead a high to very high power requirement, which should be available with as little delay as possible. Lifting requires high power.

However, the short-term increase in power requirement that occurs during a working cycle (highly dynamic power increase) poses a problem for certain engine concepts, as the combustion chambers of the internal combustion engine must be supplied with a significantly increased amount of air within an extremely short response time, which often cannot be achieved using the regular air path of the engine. For example, this problem is known as turbo lag.

From US 2010/0236232A1 a working machine is known that recuperates hydraulic energy when lowering a load. In the known system solution, the hydraulic energy previously recuperated and stored in a pressure accumulator is reused to drive a hydraulic engine, which then feeds mechanical power directly into the drive system of the machine in the form of an internal combustion engine. However, such a system is comparatively complex to implement.

The object of the invention is therefore to disclose a working machine or method capable of overcoming the aforementioned problem.

The above object is achieved by a working machine according to the features of claim 1 or by a method for operating a working machine according to the features of claim 16.

The approach of the application according to the invention is to make the temporarily required additional charge air, which cannot be provided via the regular charge air path in a sufficiently short time, available elsewhere, wherein the necessary modification of the working machine or the internal combustion engine used requires comparatively low requirements in terms of provision and integration and the use is therefore particularly energy-efficient.

According to the invention, a working machine is therefore proposed that, in addition to an internal combustion engine, comprises at least one secondary pneumatic or hydraulic working circuit. During operation of the working machine, energy can be recuperated from the secondary working circuit and supplied to a pressure accumulator of the working machine for storage in the form of compression energy. According to the invention, the working machine comprises at least one auxiliary compressor that can be driven by the energy stored in the pressure accumulator. Said auxiliary compressor is to be understood as an additional compressor to the regular charge air path of the internal combustion engine. This means that the auxiliary compressor should only be used as an alternative under special conditions and provide compressed auxiliary charge air to the regular air path of the internal combustion engine. The regular air path comprises the air intake and the corresponding supply of combustion air to the combustion chambers of the internal combustion engine. In the regular charge air path, the intake charge air can already be compressed, e.g. by means of an exhaust gas turbocharger or a compressor driven by another means. The auxiliary compressor of the present invention is therefore to be understood as an additional compressor to any compression component of the regular charge air path.

The working machine also comprises an engine control unit configured to activate the auxiliary compressor in the event of a highly dynamic increase in the power requirement for the internal combustion engine in order to generate compressed auxiliary charge air and to supply this to the regular charge air path of the internal combustion engine, i.e. in addition to the regular charge air flow. According to the invention, the energy stored in the pressure accumulator is therefore to be used to provide the internal combustion engine with additional charge air in the event of a highly dynamic increase in the power requirement, namely until the regular air path of the internal combustion engine can provide a charge air flow of sufficient height to reach or maintain the currently desired engine operating point. In other words, the additional charge air generated by the recuperated energy is only provided temporarily and for a short time for a transitional phase of increased power. A typical example is bridging the so-called turbo lag. One example of a highly dynamic increase in the power requirement is, for example, a significant increase in the power requirement due to work to be performed by the secondary working circuit, wherein such a power requirement cannot be provided immediately by the combustion engine without the additional charge air.

Advantageously, a first hydraulic displacement unit can be provided, the pressure outlet of which is or can be connected to an inlet of the pressure accumulator. By means of the first displacement unit, a liquid fluid, preferably an oil, in particular hydraulic oil, can be supplied to the pressure accumulator, whereby compression energy can be built up and stored within the pressure accumulator.

Recuperation energy can be supplied to the pressure accumulator directly from an actuator of the working circuit, for example by hydraulic fluid flowing from the cylinder into the pressure accumulator when a hydraulic cylinder is actuated. However, energy recuperation can also take place indirectly by the first hydraulic displacement unit working in pump mode and a corresponding recuperation power being supplied via its drive shaft during corresponding operating states in which kinetic energy must be extracted from the overall system. The first displacement unit driven in this way then conveys fluid into the pressure accumulator. For example, the first hydraulic displacement unit can be integrated into the overall system in such a way that it can only draw power from a passively moving part in order to convert it into hydraulic power. This could be an axle used to move the working machine, which cannot be actively driven, but can only be moved passively and the drive shaft of the displacement unit can be driven.

However, the hydraulic displacement unit 12 can also be actuated during increased operation of the internal combustion engine 10 and thus at the expense of additional fuel consumption in order to prevent the pressure within the pressure accumulator 13 from falling below a defined minimum pressure level. This ensures that there is sufficient energy available in the pressure accumulator for the temporary provision of additional charge air even if no or less energy is currently being recuperated by the secondary working circuit.

The first hydraulic displacement unit can, for example, be driven via a power take-off of the internal combustion engine. It is also conceivable to connect the first displacement unit via a pump transfer case that is driven by the internal combustion engine. Alternatively or additionally, the first hydraulic displacement unit could also be driven independently of the internal combustion engine by an auxiliary drive, e.g. an electric drive.

The first displacement unit can be a displacement unit that operates rotationally in pump mode, such as an axial piston or in-line piston pump.

According to an advantageous embodiment, a second hydraulic displacement unit can be provided, which can be driven by means of such compression energy present in the pressure accumulator and the mechanical output power of which drives the auxiliary compressor. The second displacement unit can therefore be a hydraulic engine, preferably a high-speed hydraulic engine. In an advantageous embodiment, the hydraulic engine can be an axial piston engine or gear pump suitable for operation in the required high-speed range. A transmission gear can be connected between the second displacement unit and the auxiliary compressor.

It is particularly preferred if the second hydraulic displacement unit can also be operated in pump mode. This also enables recuperation of the auxiliary compressor's rotational energy into the pressure accumulator if, for example, it is switched off and runs out.

The auxiliary compressor can be a volumetric compressor, preferably an internal gear compressor or a gerotor compressor. The pressure accumulator used can be a bladder accumulator, diaphragm accumulator or a double piston accumulator. It is conceivable to use any type of storage system, provided it is suitable for absorbing a sufficient amount of the energy that can be recuperated in the secondary working circuit.

It makes sense for an internal combustion engine according to the invention to have such an intercooler via which the charge air flowing through the auxiliary compressor can be cooled. The auxiliary compressor can have a dedicated, downstream charge air cooler. However, it is also conceivable to feed the generated additional charge air to an integral charge air cooler of the regular charge air path, i.e. the additional charge air is already fed to the regular charge air path upstream of any charge air cooler installed there.

If the internal combustion engine already comprises a charge air compressor, in particular in the form of an exhaust gas turbocharger, it makes sense to feed the additional charge air generated by the auxiliary compressor upstream to the existing compression unit of the exhaust gas turbocharger associated with the internal combustion engine. If the regular air path of the internal combustion engine comprises a throttle valve, the additional charge air from the auxiliary compressor is preferably fed to the regular air path downstream of the throttle valve.

According to an advantageous embodiment of the invention, the pressure accumulator is connected to the secondary working circuit of the working machine via a valve arrangement, preferably at least one switchable multi-way valve. Ideally, at least three valve positions are possible via one or more valves. According to a first valve position, liquid fluid can be supplied to the pressure accumulator from the secondary working circuit as part of energy recuperation or from the first displacement unit. In a second valve position, liquid fluid can be removed from the pressure accumulator to drive the compressor or the second displacement unit. According to a third valve position, liquid fluid can neither be removed from the pressure accumulator nor supplied to the pressure accumulator. In a preferred embodiment, the pressure accumulator is connected via a three-way valve that can realise the aforementioned three valve positions. Accordingly, the pressure accumulator comprises only a single connection, which is connected to the relevant connection of the three-way valve.

Alternatively, it is also conceivable that the pressure accumulator is connected via a plurality of fluid connections. A first connection of the pressure accumulator is indirectly connected to the high-pressure outlet of the first displacement unit or to a line of the secondary working circuit, via which recuperated energy can be fed into the pressure accumulator. It makes sense to integrate a non-return valve or a functionally similar component between the connection of the pressure accumulator and the first displacement unit or said line for energy recuperation in order to prevent a backflow of fluid from the pressure accumulator in the direction of the first displacement unit or the working circuit. A second fluid connection of the pressure accumulator is preferably connected to the high-pressure inlet of the second displacement unit via a valve. The valve, which is fluidically integrated between the second displacement unit and the pressure accumulator, can be set by remote control to a first switching state in which no liquid fluid flows from the pressure accumulator in the direction of the second displacement unit, and to a second switching state in which liquid fluid flows from the pressure accumulator in the direction of the second displacement unit. Preferably, it is also provided for this embodiment that such a state can be set by suitable control of the valves and components in which the pressure accumulator can neither receive nor release fluid, regardless of the existing pressure conditions.

According to an advantageous embodiment of the invention, it is provided that the first displacement unit can be set to an idle operating state in which the power consumption of the first displacement unit from the drive system is significantly lower than during the working operation of the first displacement unit in the event that no liquid fluid is to be supplied to the pressure accumulator at the moment. Such an implementation is conceivable by means of a hydraulic valve, via which the relevant fluid flow through the displacement unit can be reduced or completely blocked. Depending on the requirements, such a hydraulic valve enables (i) opening and holding open or (ii) closing and holding closed by remote control.

Alternatively, it can also be provided that the first displacement unit can be mechanically decoupled from its drive shaft, preferably via a magnetic coupling. The coupling used can preferably assume the states (i) momentary opening, (ii) holding open, (iii) momentary closing and (iv) holding closed.

The secondary working circuit can be an open or closed hydraulic circuit. The working machine enables on-road or off-road applications. It can also be a mobile working machine or a stationary working machine.

In addition to the working machine according to the invention, the present invention also relates to a method for operating a working machine, in particular a working machine according to the present invention. According to the invention, it is proposed that energy is recuperated during operation of the secondary working circuit and stored in a pressure accumulator of the working machine. The energy stored in the pressure accumulator can then be used to drive an auxiliary compressor of the working machine, wherein additional charge air is generated by means of the auxiliary compressor, which is temporarily supplied to the internal combustion engine as additional charge air to the air path of the internal combustion engine, namely when a highly dynamic increase in the power requirement of the internal combustion engine is detected. In the event of a significant increase in the power requirement, e.g. due to work to be performed by the secondary working circuit, this power requirement can often not be provided by the combustion engine immediately, e.g. due to or as a result of an existing turbo lag. According to the method according to the invention, additional charge air is provided by the auxiliary compressor for such a case. As the auxiliary compressor is operated using stored energy from the accumulator, this additional charge air is available almost instantaneously.

Provided that the engine design is not determined by the maximum power, but primarily by the engine dynamics, the method according to the invention also allows a downsizing of the internal combustion engines used, as these can achieve an increase in engine dynamics by means of the proposed method.

If the internal combustion engine can meet the current power requirement without drawing additional charge air, the existing rotational energy of the auxiliary compressor is preferably recuperated into the pressure accumulator using the relevant conversion chain, for example by the second displacement unit operating in pump mode to drive the auxiliary compressor and feeding hydraulic fluid into the pressure accumulator.

Preferably, a first displacement unit is used to charge the pressure accumulator even if there is an insufficient amount of recuperation energy. Since such a first displacement unit is preferably driven via a power take-off of the internal combustion engine, via a pump transfer gear driven by the internal combustion engine, the first displacement unit should only have the lowest possible power consumption when not in use. It is preferred if the first hydraulic displacement unit has an idle power consumption of less than 10%, preferably less than 5% and particularly preferably less than 2% with regard to its power consumption in full-load operation.

The method is advantageous in particular if the internal combustion engine is operated with a fuel that contains molecular hydrogen. For example, the fuel used contains at least 50% molecular hydrogen or the internal combustion engine is supplied with pure hydrogen as fuel.

According to a preferred embodiment of the method, the internal combustion engine is operated with a combustion air ratio lambda that does not fall below a defined limit value of at least 1.5 during operation, or at least not permanently. Preferably, the limit value is at least 2.0 and particularly preferably at least 2.5.

The concept of the lean-burn engine, i.e. an internal combustion engine that is operated with a high combustion air ratio (lambda), is known. The presence of a combustion air ratio of lambda=2 within an engine combustion chamber means that, with regard to complete combustion of the fuel (e.g. hydrogen), there is twice the amount of air or twice the amount of oxygen in it than would theoretically be required for complete combustion of the total amount of fuel in it.

The operation of a hydrogen engine is in principle subject to a high combustion air ratio and also has potential advantages. In the range of an approximately balanced combustion air ratio, a hydrogen-fuelled internal combustion engine has a comparatively low knock limit. There is only a significantly higher knock limit in the areas of a comparatively large deviation in the stoichiometric fuel-air ratio. In internal combustion engine applications in the presence of a proportion of molecular hydrogen that is well above the stoichiometric fuel-air ratio, there is only a risk of misfiring if there is an extremely high excess of hydrogen, which is well above the corresponding operating limit for methane. In addition, unlike the combustion of fuels containing carbon, the significant increase in the emission of unburnt hydrocarbons in the combustion of molecular hydrogen does not represent a separate requirement for exhaust gas after-treatment. Furthermore, the internal combustion engine use of such fuels or fuel mixtures, which have an increasingly high proportion of molecular hydrogen, results in a high reduction in NOx emissions and a tendency to increase engine efficiency.

In order to be able to utilise these advantages on a long-term basis in a dynamically operated hydrogen engine, as well as the resulting consequential advantages of a respective reduction in the size of the exhaust gas post-treatment system and the amount of reducing agent used to break down the nitrogen oxides, it must be possible to increase the air supply in a highly dynamically operated hydrogen engine in accordance with the ability of the hydrogen supply to increase in volume, even in the case of high transient power increases. (Although hydrogen is known to be a gaseous fuel, its high time-related volume increase capability does not represent a high additional requirement, at least if the hydrogen available from the on-board tank has a high pressure level). The air volume required here, which can be greatly increased at short notice, is ensured by the extension of the working machine by the auxiliary compressor according to the invention using the method according to the invention.

According to a further advantageous embodiment of the method, the method according to the invention allows the engine speed to be reduced during partial load operation of the internal combustion engine, as additional charge air can be provided by means of the auxiliary compressor in the event of dynamic increases in the power requirements of the internal combustion engine. It makes sense for the engine speed reduction to be determined dynamically as a function of the compression energy available in the pressure accumulator. In particular, the engine speed is only reduced if the charge level of the pressure accumulator does not fall below a lower limit value. The speed reduction can also be increased as the storage volume increases.

For example, in a working machine designed according to the invention and operated with a liquid fuel, which in particular comprises a diesel engine as the internal combustion engine, the potential gain in dynamic capability made possible by the invention can preferably be used primarily for downspeeding. Accordingly, the internal combustion engine is intended to be operated at a reduced engine speed in the lower and medium working range of its operating capacity. This means that the engine speed is reduced compared to the speed at which a conventional working machine without an auxiliary compressor is operated for a comparable application. In other words, if the dynamic capacity of a particular existing engine is considered sufficiently high, it or the working machine can be expanded according to the invention. During its operation, the speed collective can then be shifted to a specific and lower level while retaining its dynamic capability. Overall, the realisation of the invention thus opens up a certain gain, which, depending on the user's preference, can be used more to increase engine dynamics or more to increase energy efficiency.

In the working machine according to the invention or in the method according to the invention, the energy recuperated from the secondary working circuit into the pressure accumulator can, for example, be obtained from a translational movement function of a single actuator of the secondary working circuit. Such an actuator is, for example, a hydraulic cylinder that actuates a segment of a lever arm of the working machine. Energy recuperation is also conceivable from a rotating movement function of a single actuator of the secondary working circuit, e.g. from an axial piston machine, which causes the acceleration and deceleration of the rotary movement of an upper carriage of the working machine. It is also possible to recuperate energy from a drive system of the working machine, which is used for the translational movement of the working machine.

### BRIEF DESCRIPTION OF THE FIGURES

Further advantages and features of the invention will be described in more detail in the following with reference to possible exemplary embodiments. In the drawings:

FIG. 1: shows a schematic circuit diagram of the invention according to a possible embodiment,

FIGS. 2a-2i: shows chronological representations of the state of a working machine and the circuit diagram for the method being carried out according to the invention,

FIG. 3: shows a schematic diagram of the fluidic integration of the auxiliary compressor according to the invention into the air path of the internal combustion engine,

FIG. 4: shows a graph comparing the torque curve over time for different engine types,

FIG. 5: shows a time-based power graph to illustrate a possible downspeeding when using the invention. and

FIG. 6: shows graphical representations of momentary values of the auxiliary compressor when the method is being carried out.

### DETAILED DESCRIPTION

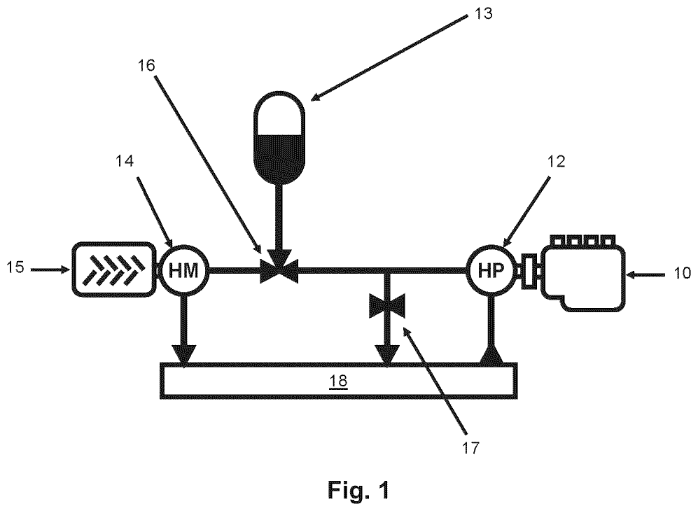

FIG. 1 shows the diagram of an embodiment of the invention. In terms of components, the internal combustion engine 10 according to the invention has a hydraulic pressure accumulator 13, a first hydraulic displacement unit (hydraulic pump) 12 and a second hydraulic displacement unit (hydraulic motor) 14, a compressor 15, also referred to as an auxiliary compressor, corresponding hydraulic valves 16, 17, hydraulic lines, a control unit and a hydraulic oil tank 18. In the event that the system according to the invention is used in such an application, in which corresponding hydraulic components are already naturally installed in an open hydraulic circuit, the hydraulic oil supply tank 18 already present due to the existing mobile hydraulics can of course also be used for those hydraulic components provided for the additional system according to the invention.

If the first hydraulic displacement unit 12 is used, it operates in pump mode. The hydraulic displacement unit 12 is preferably integrated into the overall system consisting of the internal combustion engine 10 and the power take-offs in such a way that, during corresponding operating states in which kinetic energy must be extracted from the overall system, the hydraulic displacement unit 12 can be supplied with corresponding power via its drive shaft in order to recuperate it. There is a fluid connection between the high-pressure connection of the hydraulic displacement unit 12 and the pressure accumulator 13 in order to supply hydraulic oil to the pressure accumulator 13, but a backflow of hydraulic oil from the pressure accumulator 13 in the direction of the hydraulic displacement unit 12 is avoided.

There is a fluid connection routed via a 3/2-way valve 16 between the hydraulic displacement unit 14, which is preferably designed as a hydraulic engine for 1-quadrant operation, and is particularly preferably designed as a high-speed hydraulic engine (high-speed hydraulic motor), and the pressure accumulator 13. In a first switching position of the 3/2-way valve 16, hydraulic oil can be supplied to the hydraulic displacement unit 14 from the pressure accumulator 13 and in a second switching position, this fluid connection can be interrupted.

The auxiliary compressor 15 is integrated into the overall system in such a way that it can draw rotational power from the drive shaft of the hydraulic displacement unit 14 and thus increase the supply of combustion air to the internal combustion engine 10. The mechanical coupling between the hydraulic displacement unit 14 and the compressor 15 can be achieved via a transmission gear.

The hydraulic displacement unit 12 can be designed as a power take-off of the internal combustion engine 10 or, if provided, can be attached to a pump transfer gear on the primary or secondary side. In an advantageous embodiment of the invention, the hydraulic displacement unit 12 is integrated into the overall system in such a way as to minimise the load on the internal combustion engine 10 during operating situations in which no recuperation power is available. In a configuration as shown in the graph in FIG. 1, the 2/2-way valve 17 is closed and at the same time the 3/2-way valve 16 is set so that the hydraulic fluid conveyed by the hydraulic displacement unit 12 can be supplied to the pressure accumulator 13 in the event that power is to be supplied to the pressure accumulator 13 using the hydraulic displacement unit 12. If no hydraulic fluid is to be supplied to the pressure accumulator 13 or no hydraulic fluid can be supplied, the 2/2-way valve 17 is opened, whereby the hydraulic fluid conveyed by the hydraulic displacement unit 12 is returned directly to the hydraulic oil supply tank 18.

For certain applications, a further development of the invention may be advantageous in which energy is preferably only supplied to the pressure accumulator 13 when recuperation power is available by actuating the hydraulic displacement unit 12; however, if the pressure level within the pressure accumulator 13 falls below a certain minimum pressure level, the hydraulic displacement unit 12 is actuated with increased operation of the internal combustion engine 10 and thus with the acceptance of additional fuel consumption in order to prevent the pressure level within the pressure accumulator 13 from falling below a defined minimum pressure level. This means that the possibility of providing additional charge air with the energy stored in the pressure accumulator 13 can be maintained even if the available recuperation energy is not high enough. A corresponding scenario could exist, for example, if the working machine is travelling on the road and is moving in a prolonged stop and go operation due to a current traffic situation; in particular, if these driving manoeuvres extend along an uphill section.

In addition or as an alternative to the 2/2-way valve 17, the hydraulic displacement unit 12 can be integrated into the overall system in such a way that the relevant frictional connection between the drive shaft of that hydraulic displacement unit 12 and its external drive can be specifically closed or interrupted in each case; for example, using a magnetic coupling. In addition or as an alternative to the above, such a hydraulic displacement unit 12 can be used, the conveying effect of which can be deactivated.

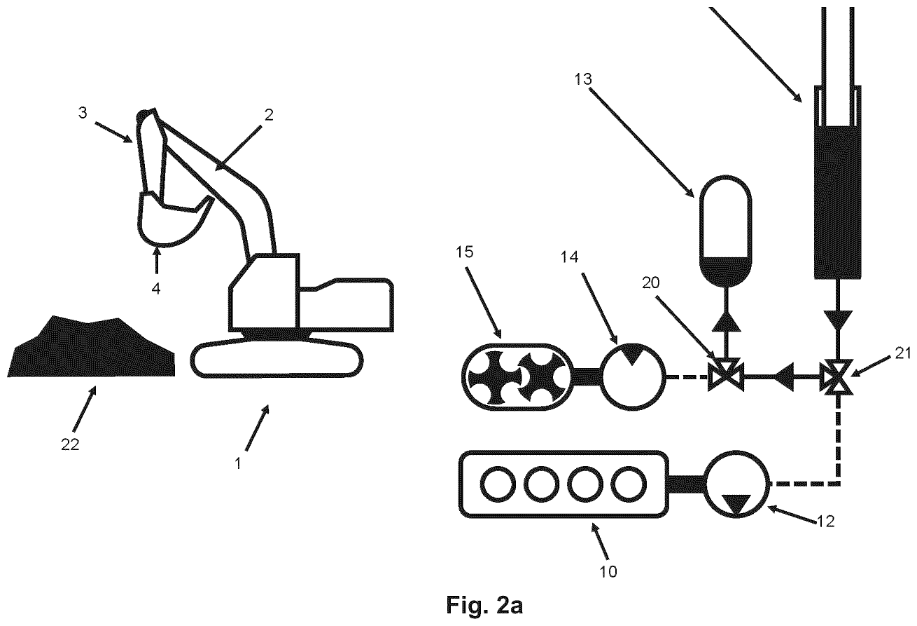

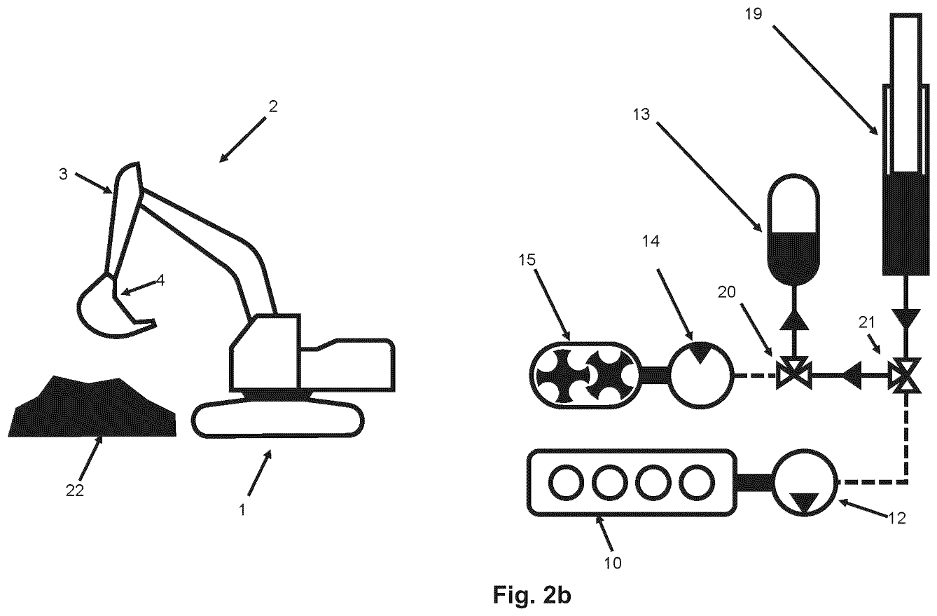

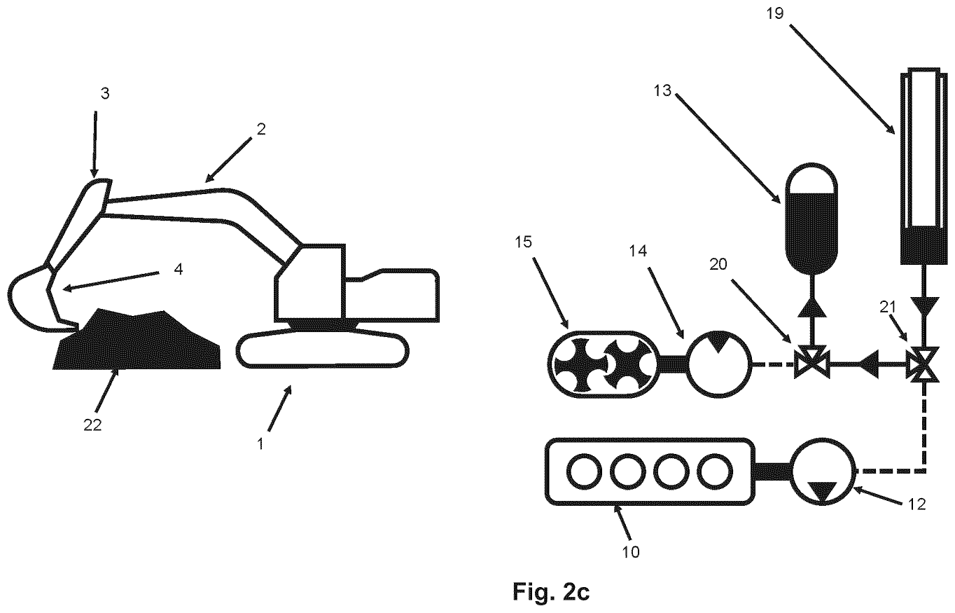

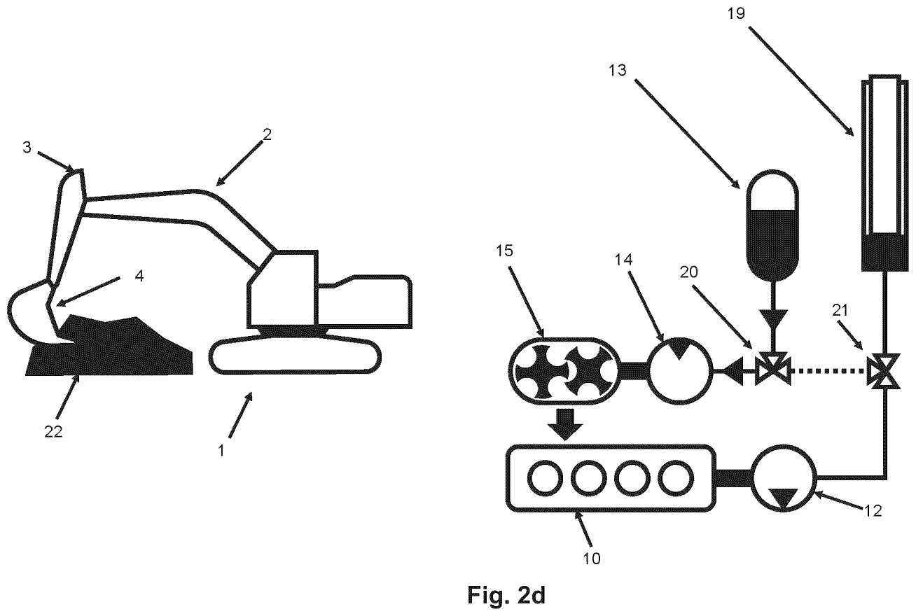

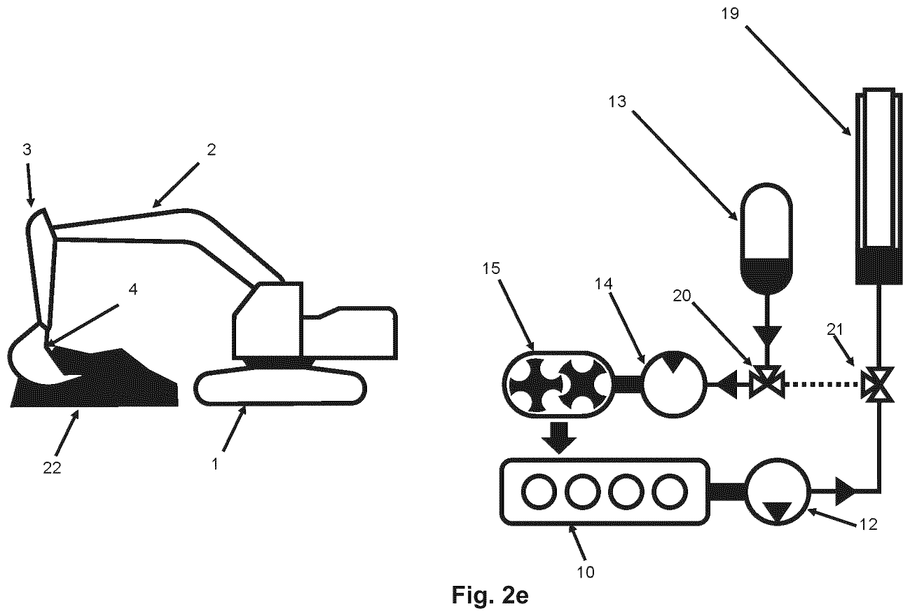

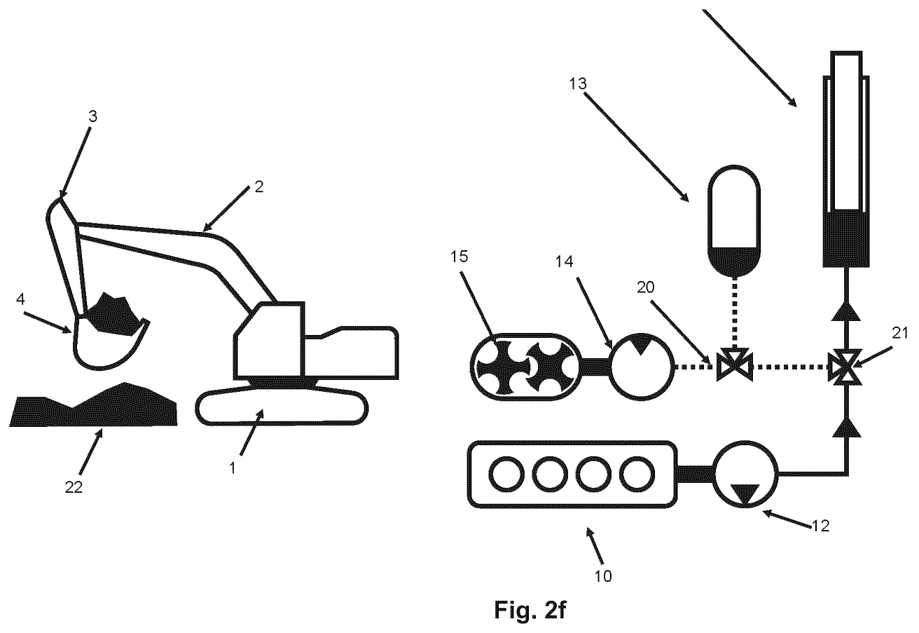

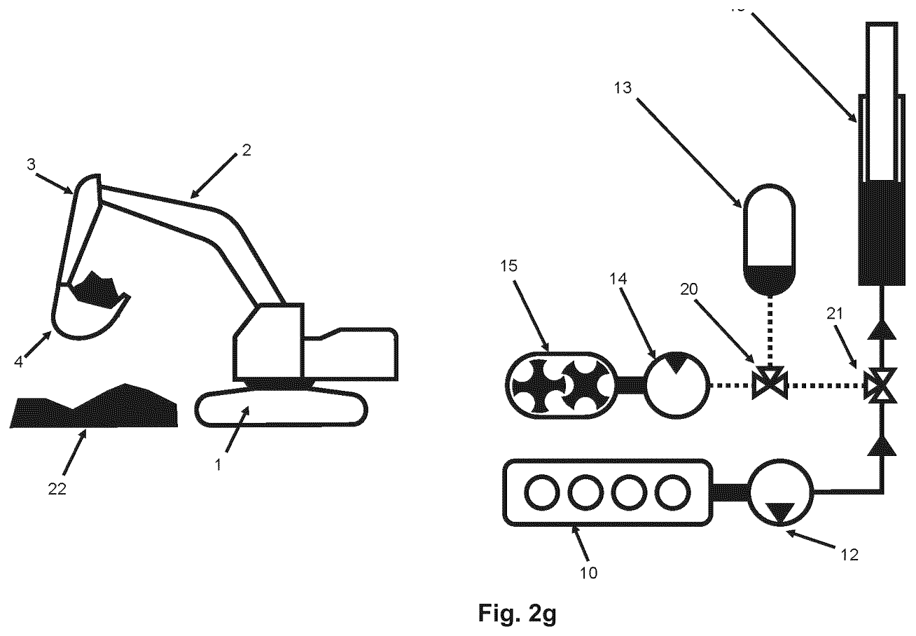

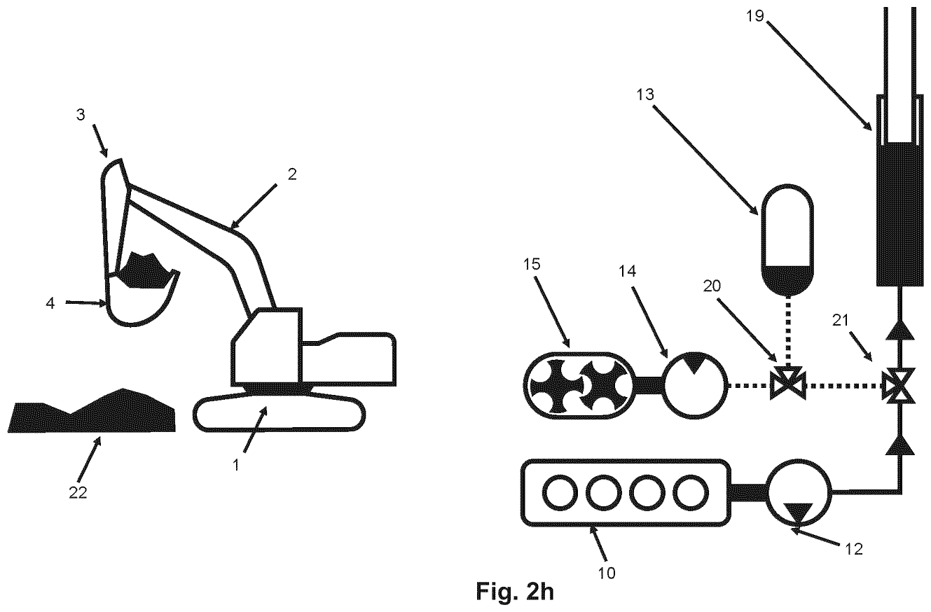

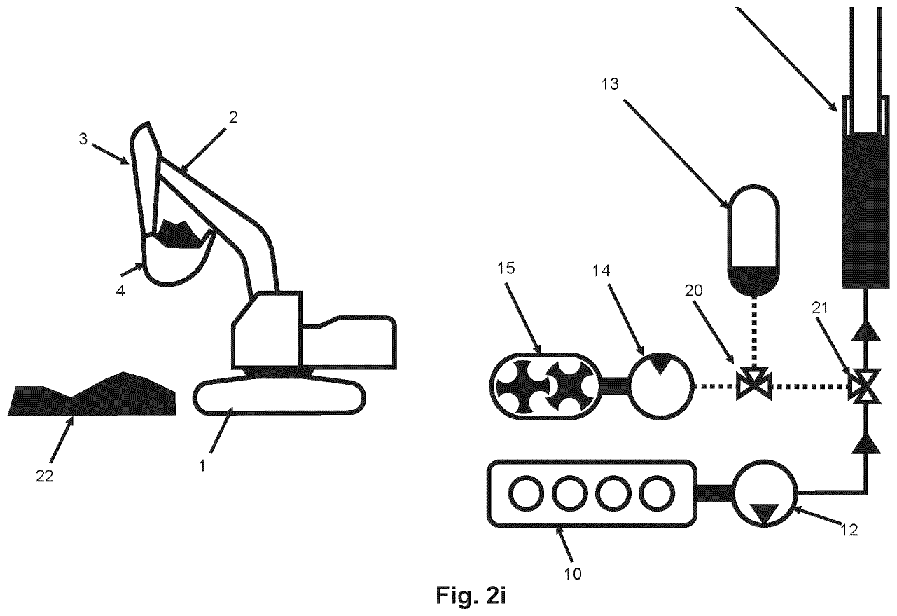

FIGS. 2a-2i each show specific snapshots of a specific embodiment of the working machine according to the invention in an exemplary application. This application involves the lever arm of an excavator 1. FIGS. 2a-2i each show a schematic silhouette of the excavator 1 on the left-hand side, while the working mode of the system according to the invention is shown on the right-hand side, wherein the excavator silhouettes and the indicated operating situations of the system according to the invention correspond in time with one another in each individual figure. The subsystem shown on the right is extensively reduced and comprises the aforementioned components internal combustion engine 10, first displacement unit 12, pressure accumulator 13, second displacement unit 14, auxiliary compressor 15. The system also contains the two 3/2-way valves 20, 21 to fluidically connect the components for the different operating states or to separate the fluid connections. The representation also shows a hydraulic cylinder 19 of the secondary working circuit of the excavator, which hydraulically actuates the lever arm of the excavator. Although the assisted movement sequence of the excavator 1 can involve the components of the lift 2, arm 3 and bucket 4, the illustrations on the right-hand side of FIGS. 2a-2i are limited to the respective representation of a single linear cylinder 19, namely the linear cylinder for actuating the lift 2. It is known to a person skilled in the art that the lift is actuated by two lift cylinders operating in parallel. Moreover, since this fact is irrelevant for understanding the exemplary embodiment of the invention presented, it is not taken into account.

In FIG. 2a, the lift of the excavator silhouette indicated on the left is in the area of its upper end stop. Corresponding to this, the piston rod of the hydraulic cylinder 19 is extended to the right in the illustration on the right-hand side of FIG. 2a. The arm 3 of the excavator silhouette is angled. The dashed connecting line to the 3/2-way control valve 21 is intended to indicate that no hydraulic fluid can flow from the hydraulic displacement unit 12 through the 3/2-way control valve 21 in the snapshot shown here. Further hydraulic displacement units, which can be driven by the internal combustion engine 10, are not shown in this considerably simplified schematic circuit diagram, nor is the regular air path of the internal combustion engine 10, etc.

A further 3/2-way valve 20 is found in the right-hand schematic circuit diagram. There is a fluid connection between the linear cylinder 19 and the pressure accumulator 13 via the two 3/2-way valves 20, 21, which is shown by the solid lines. The fact that these are each solid lines is intended to indicate that such a combination of the switching positions of these two 3/2-way valves 20, 21 exists as a result of which there is a fluid connection between the working chamber of the linear cylinder 19 and the storage volume of the pressure accumulator 13 available for holding hydraulic fluid. An arrow is drawn on each of these three solid lines in such a direction as to show that hydraulic fluid coming from the working chamber of the linear cylinder 19 can flow in the direction of the storage volume of the pressure accumulator 13. A high pressure is exerted on the hydraulic fluid pillar located inside the working chamber of the linear cylinder 13 via the piston rod due to the force of the paddle lever arm, while the fill level and thus the internal pressure inside the pressure accumulator 13 is comparatively low. If there is no corresponding hydraulic and/or mechanical blockage, the piston rod of the linear cylinder 19 moves in such a way that hydraulic fluid flows out of the working chamber of the linear cylinder 19 in the direction of the arrow markings.

In the snapshot shown in FIG. 2a, the auxiliary compressor 15 and the second hydraulic displacement unit 14 used to drive it, which is embodied as a hydraulic engine according to the circuit diagram symbol used, remain in a passive state.

A movement from the state of the excavator 1 shown in FIG. 2a to the state shown in FIG. 2b and FIG. 2c results in a comparatively low hydraulic power being required for the slight lifting of the arm 3, while a comparatively high output power is available for the lowering of the lift 2, which, according to the invention, is used to supply compression energy to the storage volume of the pressure accumulator 13. Accordingly, the blade arm consumer system has a low power requirement for the internal combustion engine 10 and hydraulic energy can be recuperated in the pressure accumulator 13. A snapshot of the movement of the blade arm and the changes in the filling levels of the pressure accumulator 13 and the linear cylinder 19 is shown in FIG. 2b on the right. A snapshot at a later point in time, shortly before the bucket 4 is pushed in to pick up the bulk material 22, is shown in FIG. 2c. In this way, part of the dissipating lifting energy can be converted into compression energy by forcing hydraulic oil into the pressure accumulator 13, which is designed as a bladder accumulator, diaphragm accumulator or double piston accumulator, for example.

FIGS. 2d and 2e show two consecutive snapshots that represent the pushing of the bucket 4 into the bulk material 22. Within the intervening period, there may be a slight further lowering of the lift, which is of secondary importance in relation to the respective power conversions within the linear cylinders, which determine the position changes of the three components in focus: lift 2, arm 3 and bucket 4 during that operating phase, which is why in the illustrated linear cylinder 19, via which the movement of the lift is determined, no change in the filling level can be seen by a simple visual inspection when comparing FIGS. 2d and 2e.

For the linear cylinder that now produces the required movement of the arm 3, there is a much higher requirement for hydraulic power during that time interval. That linear cylinder is not shown in the said schematic circuit diagrams, which show the sequence of movements of the bucket arm in question, wherein the linear movement by which the piston rod in question is positioned in its axial direction is self-explanatory from the overall context.

With regard to the section of the working sequence in focus here, in which the bucket 4 is pushed into the bulk material 22, the beginning of a more or less sudden increase in the power requirement that the internal combustion engine 10 must serve can be seen from a temporally detached perspective. Increases in requirement are far less predictable in terms of timing. An operation according to the invention for the efficient execution of the described operation now provides that hydraulic power is supplied from the pressure accumulator 13 to the hydraulic motor 14 by releasing the corresponding fluid connection by means of the valve 20. As a result, the auxiliary compressor 15 is set to its intended operating mode and remains in this mode for a certain period of time. It takes a comparatively short time for the auxiliary compressor 15 to generate the required additional charge air and feed it to the air path of the internal combustion engine when required. Such a requirement exists if there is an extremely high increase in the target output of the internal combustion engine in absolute terms and also in relation to the required rate of increase and that requirement can be met by the fuel supply system due to its design and suitable operating capability, or at least can be met to such an extent that a sufficiently high air supply volume cannot be provided within the currently existing state of the regular air path using this path alone. A more detailed focus on the charge air feed support achieved by using the auxiliary compressor 15 is provided in a separate section.

Depending on the design of the relevant subsystem, the available recuperation energy and the required air support from the auxiliary compressor 15 and, above all, the current bulk material conditions, it is possible that in a first scenario the ability to supply additional charge air to the internal combustion engine 10 is already exhausted or would be exhausted before the penetration of the bucket 4 into the bulk material 22 is completed (e.g. due to an empty pressure accumulator). However, in another scenario, support by additional charge air may still be possible if the lifting of the bulk material in the bucket 4 has already begun or even been completed. An application according to the first scenario does not represent a disadvantage, provided that the charge air support that can be provided by means of the auxiliary compressor 15 can be provided to such an extent in terms of time and quantity until the internal combustion engine 10 can be operated without the action of the auxiliary compressor and, as a result, there is no restriction of its current power output capacity, i.e. that, for example, the potential occurrence of the phenomenon known as turbo lag has already been overcome.

FIGS. 2f, 2g, 2h and 2i show three consecutive snapshots of the lifting of the bucket 4 filled with bulk material 22. In these operating states, the multi-way valve 20 is closed and interrupts any fluid flow to and from the pressure accumulator 13. Instead, the linear cylinder 19 can be filled with hydraulic oil, which is conveyed from the hydraulic displacement unit 12 to the linear cylinder 19 through the multi-way valve 21.

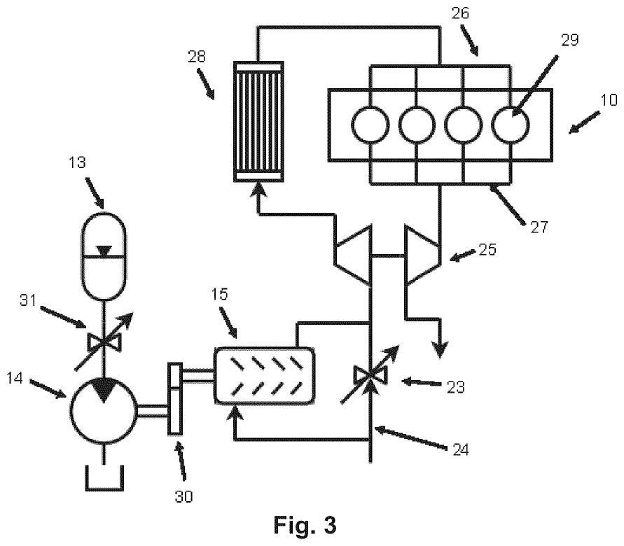

FIG. 3 shows a schematic diagram of how the additional compressor 15 can be connected as an addition to the regular charge air path of the internal combustion engine 10. For the sake of simplicity, the above figure does not show the way in which liquid hydraulic fluid can be supplied to the pressure accumulator 13, as this has already been shown in detail above with reference to FIGS. 2a to 2i and the text referring to them. In the embodiment shown in FIG. 3, the internal combustion engine is a hydrogen engine 10, which is why a throttle valve 23 is provided along the regular air path 24. However, the following explanations are not limited to an embodiment as a hydrogen engine. Advantageously, the throttle valve 24 is arranged in such a way that its possible throttling effect for the air path extending via the auxiliary compressor 15 is completely absent. The regular air path 24 extends via a compressor stage in the form of an exhaust gas turbocharger 25, which is arranged downstream of the supply line section at which both partial air flows, i.e. the air flow permanently extending via the throttle valve 23 and the air flow optionally generated by the auxiliary compressor 15, are brought together. With regard to the internal combustion engine 10, four cylinders 29, the air distributor 26, the exhaust manifold 27, an intercooler 28 and the turbocharger 25 are shown by way of example.

In order to provide the combustion chambers with a significantly increased mass flow of charge air after only a short response time in the event of a corresponding demand, the auxiliary compressor 15 shown is driven by the hydraulic displacement unit 14, which is preferably designed as a high-speed hydraulic engine. The auxiliary compressor 15 is preferably a volumetric compressor, in particular a gerotor compressor or an internal gear compressor. In order to achieve a sufficiently high compressor speed, having a value of 15,000 revolutions per minute and preferably 20,000 revolutions per minute, the torque is transmitted between the hydraulic engine 14 and the compressor 15 via a transmission gear 30. So that the hydraulic engine 14 can provide the compressor 30 with mechanical power at a defined predeterminable level, it draws hydraulic power, which can be provided by the pressure accumulator 13 and extends via a fluid connection running through a controllable valve 31. Advantageously, the valve 31 is adjusted via a control circuit, wherein the required valve position is preferably determined by a control unit.

The following are examples of component designs for use in a hydrogen engine with intake manifold injection:
Hydrogen engine 10:
   Displacement approx. 10 litres/power of 200 kW/application in a 30 t excavator for earthmoving
   Displacement approx. 15 litres/power of 450 kW/application in an 80 t excavator for earthmoving
Pressure accumulator 13, designed as a bladder accumulator:

The capacity for the liquid fluid is 2 litres to 6 litres, the presence of which in the accumulator compresses the required gas pressure level to a maximum pressure of 240 bar.
Compressor 15 for providing the additional charge air:
   Delivery rate 900 kg/h to 2000 kg/h
   Technology:
      A volumetric compressor is preferred, in particular a gerotor compressor or an internal gear compressor (speed range up to 20,000 rpm at least 15,000 rpm); alternatively, an external gear compressor could also be used, accepting certain disadvantages.
      Less suitable, but still possible, is a dynamic compressor (screw compressor), as the extremely high speeds (50,000 rpm to 100,000 rpm) require another transmission with a high transmission ratio to the high-speed hydraulic engine 14.

### Exemplary Embodiment for a Diesel Engine

Diesel engine with intake manifold injection, a displacement of 9 litres and an output of 200 kW; 13.5 l at 450 kW.
Pressure accumulator and application as mentioned above.

Possible advantageous modifications of the aforementioned working machine or the method according to the invention are described below.

### Expansion

The system has a control function that sets a dynamic threshold value for a speed reduction for the internal combustion engine 10. In the event that the compression energy already present within the pressure accumulator 13 is sufficiently high, the motor speed target value is set to a minimum limit value when the power requirement is low. If the currently available compression energy within the pressure accumulator 13 is lower, that lower engine speed target value is set to a threshold that is higher than the aforementioned minimum limit value in accordance with the shortfall in compression energy within the pressure accumulator 13.

### Systems

The hydraulic displacement unit 12, via which recuperation can take place, is used
   (i) both for working mode or primarily for working mode and can also be used for recuperation:
      Example 1: Linear cylinder 19 that performs work to lift a load and can deliver hydraulic power when that load is lowered;
      Example 2: Hydraulic displacement unit that performs the slewing movement of the upper carriage of an excavator
   (ii) only for recuperation:
      Hydraulic pump that can draw torque from a power take-off of the internal combustion engine, from a power take-off of a pump transfer gear or from a passive drive axle, i.e. an axle to which no drive energy is supplied by the drive system in order to be able to form its own torque.
The hydraulic displacement unit, which can be used for recuperation, is an energy converter (i) between rotational power and hydraulic power or (ii) between lifting power and hydraulic power.

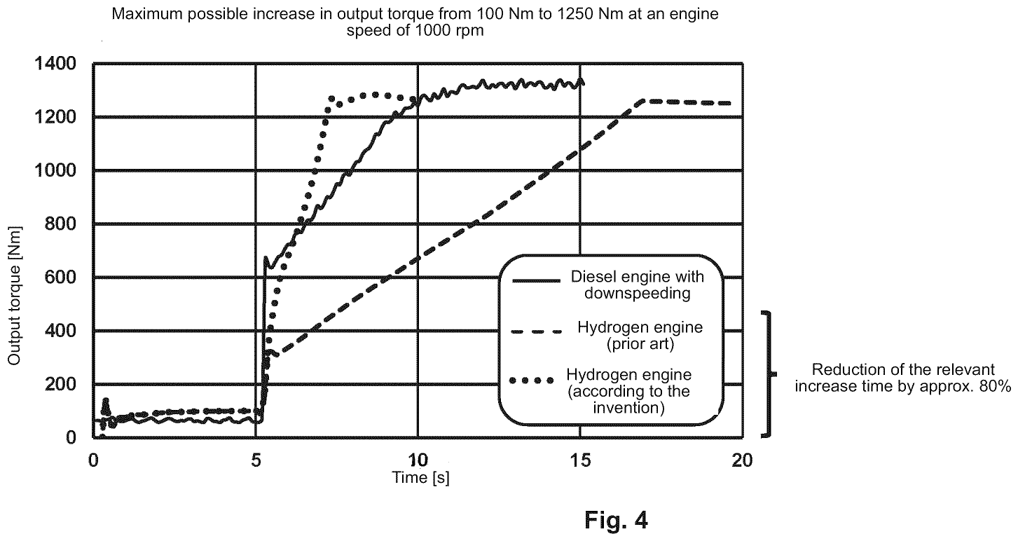

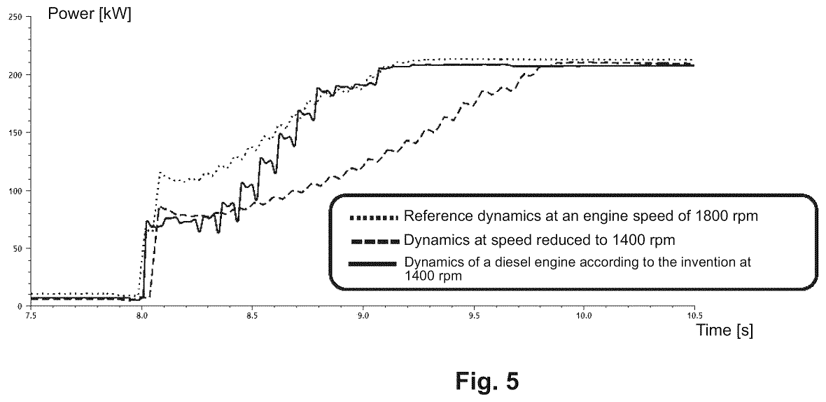

The advantages achievable by the invention can be summarised as follows:
Starting from a low charge air supply rate, a considerable increase in the charge air supply rate can be achieved within a short period of time. See, for example, FIG. 4, which shows in a graph the possible output torque over time for a hydrogen engine and a diesel engine with downspeeding. In particular, the graph shows the curve for a conventional hydrogen engine, i.e. a hydrogen engine according to the prior art (dashed line) and for a hydrogen engine with the auxiliary compressor 15 according to the invention (dotted line). The achievable increase in dynamics can be seen in this comparison, as the desired higher output torque is available much faster with the embodiment according to the invention. In addition, the solid line in the graph in FIG. 4 shows the torque curve for a diesel engine that is operated with downspeeding, i.e. a reduction in the speed collective. As a result of the use of the invention, sufficient dynamic capability of the diesel engine can also be ensured here despite downspeeding.
Application in a dynamically operated gas engine that is to be operated with a consistently high excess air->the embodiment according to the invention enables a high increase in dynamic capability at a comparatively low cost.
Application in a dynamically operating internal combustion engine running on liquid fuel->the gain in dynamic potential can be used in full or in part for downspeeding. Overall, there is scope for optimisation, as the increase in dynamic capability offers scope for operating the internal combustion engine at a lower speed in the low to medium power output range. A comparison of the engine power for a diesel engine without speed reduction (1800 rpm), a diesel engine with speed reduction to 400 rpm but without an auxiliary compressor and a diesel engine with speed reduction to 1400 rpm and an auxiliary compressor according to the invention can be seen in FIG. 5. It can be seen here that a diesel engine according to the invention comes close to the engine power of the diesel engine without speed reduction, irrespective of a speed reduction from 1800 rpm to 1400 rpm.
System solution is robust/long-lasting in terms of service life and operational loads.
System solution is comparatively inexpensive in terms of acquisition and maintenance costs.
System solution can be limited to the use of components that belong to technology areas that are already used as standard with regard to the range of applications of mobile working machines.
Modularity, (in particular because the use of a system according to the invention is very advantageous for a particular application [e.g. for an excavator used for excavation work], whereas the presence of a system according to the invention on the same basic machine, but used for a different application, cannot bring about any significant increase in efficiency [e.g. for an excavator used for house demolition work].
Can be used for specific applications on a single output, on several outputs or for a group of several or all outputs [application example excavator: example 1 of the system according to the invention for the lift; example 2 for the slewing gear].
Can be retrofitted.

In contrast to a hybrid drive system known from the prior art, the temporary power deficit of the internal combustion engine is not reduced by the use of an additional drive in a corresponding operating situation, but the invention makes it possible to prepare the internal combustion engine to deliver correspondingly higher power in a shortened and thus acceptable time. As a result, although the full potential of recuperable energy available in principle is often not utilised, the additional equipment is comparatively inexpensive, compact and therefore more suitable as an optional extra and is also more suitable for retrofitting to an existing vehicle.

If an internal combustion engine is operated in a highly dynamic manner and is always to operate while maintaining a high combustion air ratio lambda, i.e. even if there is a (time-related) short-term demand for a high increase in engine output (in relation to the total amount), the internal combustion engine in question must be designed in such a way that each of the combustion chambers can be provided with a correspondingly significant time-related and quantity-related increase in the air supply volume when required.

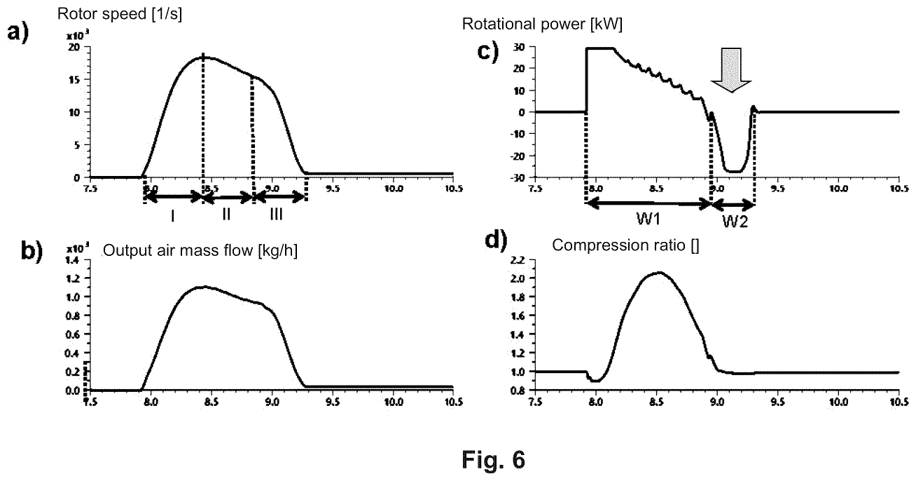

The graphs in FIG. 6 show the respective time progression of four instantaneous variables that occur during the activity phase of the compressor 15. The first section I of the bulge-shaped rotor speed-time curve (FIG. 6a) and the associated time curve of the air mass flow exiting the volumetric compressor (FIG. 6b) shows the acceleration phase I. Due to the correspondingly high air requirement, the rotor pair has a significant inertia in line with its required size. Added to this is the need to achieve a high speed. Therefore, a certain period of time (here approx. 0.5 s) elapses until the volumetric compressor 15 can provide an air mass flow corresponding to the initial target value.

Due to the increase in air support caused by the volumetric compressor 15 and the accompanying increase in the fuel supply rate, there is a particularly significant increase in the exhaust gas energy exiting the internal combustion engine, resulting in a very high increase in the charge air compression caused solely by the exhaust gas turbocharger 25. For this reason, the relevant support of the volumetric compressor 15 can be reduced quite significantly and at short notice after reaching its maximum support, which is achieved by a corresponding control that causes a correspondingly adapted throttling of the hydraulic fluid flowing out of the pressure accumulator 13. This leads to a reduction in the charge air compression effected by the volumetric compressor 15 via the hydraulic engine 14. This reduction can be seen in the two graphs in FIGS. 6a and 6b and affects the middle time interval II of the three marked sections. Due to the high mass moment of inertia of the two rotors of the volumetric compressor 15, the air compression decreases but initially continues to remain and can in principle be utilised. As far as the time period is concerned, this availability only exists over a short time interval. However, if you look at the power curve shown in the graph in FIG. 6c, you can see that the energy content is by no means negligibly small in relation to the total energy content that has been introduced into the volumetric compressor 15. This, in turn, opens up a particularly interesting perspective for such devices in which there is a certain energy recuperation potential, but this is too low to generate a charge air support which in turn has a sufficient level to be able to bridge the turbo lag according to the invention. In fact, a corresponding extension of the system according to the invention could ensure that part of that rotational energy is converted accordingly, whereby a certain amount of energy is fed back to the pressure accumulator 13, whereby an overall energy supply is available therein, which enables a sustainable supply of the volumetric compressor 15.

1. Working machine comprising an internal combustion engine and at least one secondary pneumatic or hydraulic working circuit, wherein during operation of the secondary working circuit, energy is recuperated and can be supplied to a pressure accumulator of the working machine for energy storage, wherein at least one auxiliary compressor is provided, which can be driven by the energy stored in the pressure accumulator, and an engine control unit is provided and configured to recognise a highly dynamic increase in the power demand on the internal combustion engine and, if necessary, to generate additional charge air by means of the auxiliary compressor, which is fed to the charge air path of the internal combustion engine in addition to the regular charge air flow of the internal combustion engine.

2. Working machine according to claim 1, wherein a first hydraulic displacement unit is provided to supply a liquid fluid to the pressure accumulator.

3. Working machine according to claim 2, wherein the first hydraulic displacement unit is driven via a power take-off of the internal combustion engine or via a pump transfer gear driven by the internal combustion engine and/or via an auxiliary drive.

4. Working machine according to claim 2, wherein the first hydraulic displacement unit is a displacement unit that operates rotationally during pump operation.

5. Working machine according to claim 1, wherein a second hydraulic displacement unit is provided, which can be driven by means of the compression energy stored in the pressure accumulator and the mechanical output power of which is used to drive the auxiliary compressor.

6. Working machine according to claim 5, wherein the second hydraulic displacement unit is a hydraulic engine.

7. Working machine according to claim 5, wherein the second hydraulic displacement unit can be operated in pump mode, whereby energy can be recuperated from the rotational energy of the auxiliary compressor into the pressure accumulator.

8. Working machine according to claim 5, wherein a transmission gear is connected between the auxiliary compressor and the second displacement unit.

9. Working machine according to claim 1, wherein the auxiliary compressor is a volumetric compressor.

10. Working machine according to claim 1, wherein the pressure accumulator is a bladder accumulator, diaphragm accumulator or a double piston accumulator.

11. Working machine according to claim 1, wherein the additional charge air generated by the auxiliary compressor can be fed to the air path of the internal combustion engine via at least one charge air cooler.

12. Working machine according to claim 1, wherein the additional charge air of the auxiliary compressor can be fed to the charge air path of the internal combustion engine upstream of a compressor of the internal combustion engine.

13. Working machine according to claim 1, wherein the regular charge air path of the internal combustion engine comprises a throttle valve and the additional charge air from the auxiliary compressor can be fed to the charge air path downstream of the throttle valve.

14. Working machine according to claim 1, wherein the pressure accumulator is integrated into the secondary working circuit via a switchable valve arrangement, including at least one multi-way valve, wherein liquid fluid can be supplied to the pressure accumulator for energy storage in a first valve position, liquid fluid can be removed for driving the auxiliary compressor in a second valve position and liquid fluid can neither be removed from the pressure accumulator nor supplied to the pressure accumulator in a third valve position.

15. Working machine according to claim 1, wherein the first displacement unit can be mechanically decoupled from its drive shaft.

16. Method for operating a working machine having an internal combustion engine and at least one secondary working circuit, wherein during operation of the secondary working circuit, energy is recuperated and stored in a pressure accumulator of the working machine, wherein when a highly dynamic increase in the power requirement of the internal combustion engine is detected, an auxiliary compressor is driven by the extraction of such energy stored in the pressure accumulator in order to supply additional charge air to the internal combustion engine.

17. Method according to claim 16, wherein rotational energy of the auxiliary compressor, which remains after the end of compressor operation to generate the additional charge air, is recuperated into the pressure accumulator by a second displacement unit operating as a pump to drive the auxiliary compressor.

18. Method according to claim 16, wherein the first hydraulic displacement unit has an idle power consumption of less than 10% with regard to its power consumption in full-load operation.

19. Method according to claim 16, wherein the internal combustion engine is powered with a fuel that contains molecular hydrogen.

20. Method according to claim 16, wherein the combustion air ratio lambda of the internal combustion engine does not fall below a defined limit value, wherein the limit value is a value of at least 1.5.

21. Method according to claim 16, wherein in partial load operation of the internal combustion engine, the engine speed is reduced, which is determined dynamically as a function of the compression energy available in the pressure accumulator.

22. Method according to claim 16, wherein the pressure accumulator is supplied recuperation energy from a motion function of an actuator of the secondary working circuit, including from a hydraulic cylinder that actuates a single segment of a lever arm, and/or from a rotary motion function of a single actuator of the secondary working circuit, including from an axial piston machine that effects the acceleration and deceleration of the rotary movement of an upper carriage of the working machine, and/or from a drive system of the working machine used for the translational movement of the working machine.
